(19) United States
(12) Patent Application Publication
(10) Pub. No.: US 2025/0018997 A1
(43) Pub. Date: Jan. 16, 2025

(54) ACTUATOR FOR AN AXLE STEERING SYSTEM OF A VEHICLE, AND AXLE STEERING SYSTEM HAVING SUCH AN ACTUATOR

(71) Applicant: Schaeffler Technologies AG & Co. KG, Herzogenaurach (DE)

(72) Inventors: Tobias Kirchgäßner, Fürth (DE); Sebastian Krueger, Fürth (DE)

(73) Assignee: Schaeffler Technologies AG & Co. KG, Herzogenaurach (DE)

(21) Appl. No.: 18/712,924

(22) PCT Filed: Nov. 4, 2022
(86) PCT No.: PCT/DE2022/100813

§ 371 Date: May 23, 2024

(30) Foreign Application Priority Data
Nov. 29, 2021 (DE) 10 2021 131 245.0

(51) Int. Cl. B62D 5/04; B62D 12/00

(52) U.S. Cl. CPC B62D 5/0442; B62D 12/00

(57) ABSTRACT

The disclosure relates to an actuator for an axle steering system of a vehicle that includes a push rod which is movable longitudinally within a housing, and a target holder for a target that is fastened releasably to the push rod. The target is designed to interact with a stationary sensor arrangement, and the target holder comprises a base part for receiving the target and at least one first clip contour, which is integrally formed on the base part, engages at least partially around the push rod and has a first clip arm and a second clip arm. The invention further relates to an axle steering system having such an actuator and to a vehicle having such an axle steering system.

### CROSS-REFERENCE TO RELATED APPLICATIONS

This application is the U.S. National Phase of PCT Application No. PCT/DE2022/100813 filed on Nov. 4, 2022, which claims priority to DE 10 2021 131 245.0 filed on Nov. 29, 2021, the entire disclosures of which are incorporated by reference herein.

### TECHNICAL FIELD

The disclosure relates to an actuator for an axle steering system of a vehicle, comprising a push rod which is movable longitudinally within a housing, wherein the push rod has a rotation lock. The disclosure further relates to an axle steering system having such an actuator and to a vehicle comprising such an axle steering system.

### BACKGROUND

DE 10 2018 130 228 B3 discloses an actuator for a rear axle steering system of a vehicle, comprising a push rod which is movable longitudinally within a housing, wherein the push rod has a rotation lock with a guide element which is guided in the axial direction in a single-part or multi-part slide rail arranged on the housing, wherein an elastomer ring is arranged between the slide rail and the housing.

### SUMMARY

The object of the present disclosure is to propose an alternative actuator for an axle steering system of a vehicle. According to the disclosure, this object is achieved by an actuator having the features described herein and shown in the attached figures.

An actuator according to the disclosure for an axle steering system of a vehicle comprises a push rod which is movable longitudinally within a housing. A target holder for a target is fastened releasably on the push rod, and the target is designed to interact with a stationary sensor arrangement. The target holder has a base part for receiving the target and at least one first snap-fit contour integrally formed on the base part that engages at least partially around the push rod and has a first snap-fit arm and a second snap-fit arm. The essential advantage of this arrangement is that there is no need to additionally screw the target to the push rod.

The actuator is provided for setting a steering angle of vehicle wheels that are operatively connected to the actuator on a rear axle of the vehicle by axially displacing the push rod relative to the housing. This initiates or supports cornering of the vehicle, for example. For this purpose, the push rod can have at least one fork connection with a fork element at its free ends, on which the respective vehicle wheel is received at least indirectly. The push rod can be designed in one or more parts and has a threaded spindle connected to it in one or more parts and arranged concentrically therewith. The push rod can be formed in at least two parts, wherein the two push rod segments can be connected to one another via a slide. The push rod segments can be screwed into the slide, for example. This can simplify the mounting of the actuator.

A drive unit, for example in the form of an electric motor, is provided to drive an axially non-displaceable, rotationally driven threaded nut of the actuator. The threaded nut is operatively connected to a threaded spindle. The threaded nut is arranged such that it can rotate in relation to the housing and is mounted and supported on the housing accordingly. The threaded spindle is arranged at least indirectly on the push rod, and the threaded spindle together with the push rod, and possibly the slide, is moved longitudinally or set into a longitudinal movement relative to the housing or the threaded nut by a rotation of the threaded nut. Consequently, the threaded spindle and the threaded nut form a screw drive, and the rotary drive of the threaded nut at least indirectly causes a linear adjusting movement of the push rod for setting the steering angle. Furthermore, the drive unit can comprise a transmission device which is designed, for example, as a belt transmission and is operatively connected to the threaded nut.

The target fastened on the push rod interacts with the sensor arrangement, which can be fastened to the housing. The target is movable with the push rod relative to the stationary, in particular fixed to the housing, sensor arrangement, in order to be able to determine, in particular, an axial position of the push rod relative to the housing. The sensor arrangement comprises a sensor cover which is fastened when it is mounted on the housing of the axle steering system. The target is supported on the sensor cover in the circumferential direction and guided by it.

In the region of the target, the push rod can be designed as a shaft, in particular with an essentially circular cross-section. The snap-fit arms of the respective snap-fit contour form an essentially C-shaped, concave inner surface that is formed in a manner complementary to an outer surface of the push rod. The snap-fit contour forms a partial ring surface with the snap-fit arms, the circumference of which is in any case larger than half the circumference of the push rod, so that the snap-fit arms snap into place when the target holder is mounted on the push rod and thus create a form-fitting connection with the push rod. This prevents radial detachment of the target holder from the push rod.

At least one of the snap-fit arms, in an example embodiment, both snap-fit arms, are elastically deformable in order to implement the snap-fit mounting of the target holder on the push rod. After mounting the target holder, the snap-fit arms engage around the push rod at least partially, in particular around more than half the circumference of the push rod, and thus secure the target holder on the push rod in a radial direction or support the target holder radially on the push rod.

The target holder can comprise a second snap-fit contour axially spaced apart from the first snap-fit contour and having a first snap-fit arm and a second snap-fit arm. The two snap-fit contours can be identically designed, wherein the push rod is thus engaged around at two axial positions by the snap-fit contours of the target holder. By providing two or more axially spaced apart snap-fit contours, tilting of the target holder relative to the push rod can be prevented. In particular, the target holder is prevented from pitching. Thus, the target holder is arranged on the push rod in a more stable manner.

The disclosure includes the technical teaching that the push rod has a radial tapering for radially receiving the respective snap-fit contour. In other words, the push rod has a radial recess in the region of the target holder. This secures the target holder on the push rod in the axial direction. The target holder is therefore supported axially on the push rod.

The respective snap-fit contour secures the target holder at least against radial movement relative to the push rod. The elastic properties of the respective snap-fit contour or the snap-fit arms are selected such that unintentional detachment of the target holder from the push rod in the radial direction is prevented. Consequently, the snap-fit arms of the respective snap-fit contour are designed to be so elastic or soft that the target holder can be mounted on the push rod, and so rigid that the target holder cannot be unintentionally detached from the push rod.

In order to prevent the target holder from rotating relative to the push rod, at least one resiliently deformable spring tab is formed, in each case, on the base part on the side surfaces guided by the housing, which spring tab is designed to secure the target holder against rotation relative to the sensor arrangement. In other words, at least one spring tab each is formed on two opposite side surfaces on the base part. The side surfaces of the base part extend essentially parallel to the direction of movement or longitudinal direction of the push rod. The spring tabs support the target holder in the circumferential direction on the housing and ensure longitudinal guidance of the target holder on the sensor arrangement. The target holder is therefore held in a rotational normal position by the spring tabs. This improves the measuring accuracy of the sensor arrangement. Consequently, the susceptibility of the sensor arrangement to measurement errors is reduced. The spring tabs further compensate for manufacturing tolerances on the sensor arrangement and/or target holder. In particular, the stiffness of the spring tabs is selected such that their reaction force is greater than the resulting torque from the torsion of the push rod. This ensures that the target holder always remains in its rotational neutral position.

The spring tabs have resilient properties. The term “resilient” means here that the material of the respective compression spring behaves according to Hooke's law in its working range and therefore has a spring constant. This is a material property in which a deformation or deflection caused by an external force results in an immediate rebound of the respective spring tabs when the external force is removed. The same applies to the snap-fit arms of the respective snap-fit contour.

The sensor arrangement can have a receptacle into which the base part with the target projects at least partially. In an example embodiment, the sensor cover of the sensor arrangement has the receptacle. In a further aspect, the spring tabs are arranged within the space formed by the receptacle of the sensor arrangement and are supported laterally on the inner wall of the sensor arrangement in relation to the direction of movement of the push rod in order to implement the rotation lock of the target holder.

According to an alternative exemplary embodiment, the spring tabs are designed and formed on the base part such that they project from the space defined by the receptacle of the sensor arrangement in the direction of the snap-fit contour of the target holder. In this sense, the spring tabs can be designed such that they pre-position the target holder relative to the housing before the sensor arrangement is mounted on the housing. When mounting the actuator, after mounting the push rod in the housing, the target holder is mounted on the push rod as described above by snapping the snap-fit arms of the respective snap-fit contour onto the push rod. In the process, the spring tabs implement an intermediate positioning of the target holder relative to the push rod and relative to the housing and pre-center the target holder until the sensor arrangement is mounted.

The spring tabs can also be designed such that they guide the target holder on the sensor arrangement and do not come into contact with the housing after the sensor arrangement has been mounted on the housing. Consequently, once the sensor arrangement has been mounted, an intermediate positioning of the target holder on the housing is no longer necessary, wherein the target holder is guided and secured against rotation exclusively via the spring tabs that are supported on the sensor arrangement after the sensor arrangement has been mounted. The sections with which the spring tabs previously came into contact with the housing as part of the intermediate positioning no longer come into contact with the housing. When the sensor arrangement is mounted, the spring tabs continue to deform elastically and are pressed inwards in such a way that they are only supported on the sensor arrangement, in particular on the inner wall of the receptacle of the sensor arrangement, and no longer on the housing.

The term “at least indirectly” means here that two components are connected to one another via at least one other component that is arranged between the two components, or are immediately and thus directly connected to one another. In other words, the target holder can be arranged on the push rod via an intermediate component.

The target holder can be made of plastic. In particular, the target holder, i.e., the base part and the respective snap-fit contour, are manufactured integrally by means of injection molding.

Such an actuator can be used in an axle steering system of a vehicle according to the disclosure, in particular in a front axle steering system and/or a rear axle steering system. The vehicle can have multiple front or rear axles, wherein one or more of the front or rear axles has/have a respective axle steering system with an actuator of the previously described type.

### BRIEF DESCRIPTION OF THE DRAWINGS

Further measures improving the disclosure are described in more detail below together with the description of two exemplary embodiments of the disclosure with reference to the figures, wherein identical or similar components are marked with the same reference sign. In the drawings:

FIG. 1 shows a simplified schematic view of an axle steering system according to the disclosure,

FIG. 2 shows a schematic partial cross-sectional view of an actuator of the axle steering system according to the disclosure shown in FIG. 1 according to a first embodiment in a first axial position,

FIG. 3 shows a schematic partial cross-sectional view of the actuator according to the disclosure shown in FIG. 2 in a second axial position,

FIG. 4 shows a schematic perspective view of a target holder of the actuator according to the disclosure shown in FIG. 2 and FIG. 3,

FIG. 5 shows a schematic view of the target holder shown in FIG. 1, and

FIG. 6 shows a schematic view of the target holder of the actuator according to the disclosure according to a second embodiment.

### DETAILED DESCRIPTION

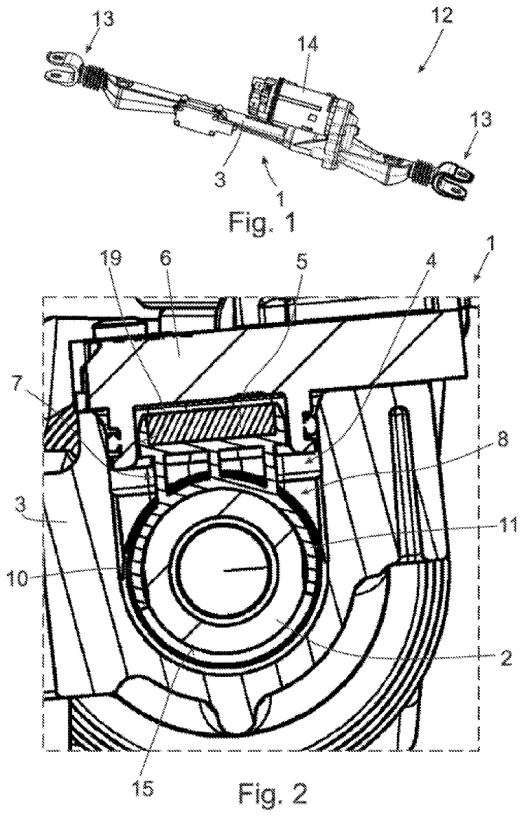

FIG. 1 shows an axle steering system 12 designed as a rear axle steering system for a vehicle—not shown here—which comprises an actuator 1 having a housing 3 in which a push rod 2, shown in an exemplary manner in FIG. 2, is guided longitudinally. The push rod 2 can be used to set the steering angle of the respective vehicle wheels—also not shown here—which are arranged at least indirectly on the fork elements 13 of the axle steering system 12. Furthermore, the axle steering system 12 has a drive unit 14—not described in detail—which at least indirectly causes the push rod 2 to move longitudinally.

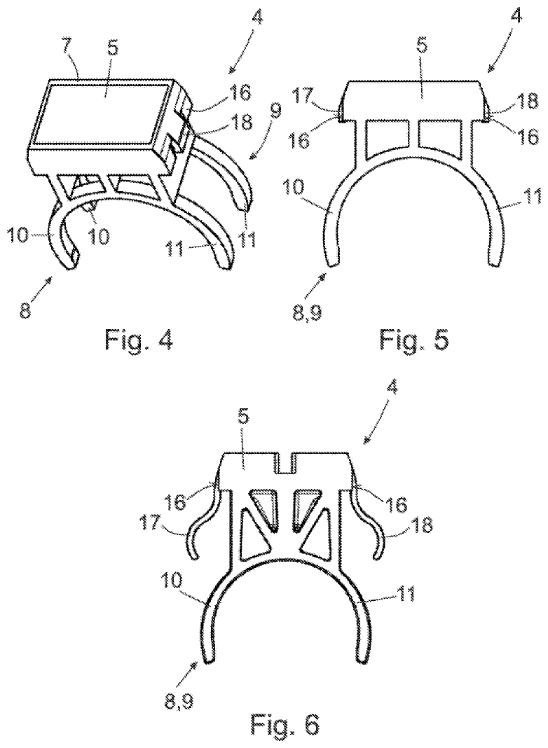

FIG. 2 shows the push rod 2 inside the housing 3. A target holder 4 for a target 5 is fastened releasably on the push rod 2, wherein the target 5 is designed to interact with a stationary sensor arrangement 6. According to FIGS. 2 to 5, the target holder 4 has a base part 7 which is arranged around the target 5. The target 5 is overmolded by the plastic of the target holder 4 and thus received on the base part 7. Furthermore, the target holder 4 has a first snap-fit contour 8 and a second snap-fit contour 9 spaced apart from it in the axial direction of the push rod 2. The two identically designed snap-fit contours 8, 9 are formed on the base part 7. Each snap-fit contour 8, 9 comprises a respective elastically deformable first and second snap-fit arm 10, 11. When the target holder 4 is mounted on the push rod 2, the snap-fit arms 10, 11 deform elastically outwards in such a way that the snap-fit arms 10, 11 slide around the push rod 2 until the target holder 4 snaps or engages around the push rod 2. The snap-fit arms 10, 11 form a C-shaped contour, the circumference of which is greater than half the circumference of the push rod 2 in the region of a radial tapering 15 of the push rod 2. The snap-fit arms 10, 11 are designed in a manner mirror-inverted to one another. The target holder 4 is therefore designed in a symmetrical manner. The snap-fit contours 8, 9 secure the target holder 4 against radial movement relative to the push rod 2.

The target holder 4 is fastened to the radial tapering 15 of the push rod 2, so that the target holder 4 is additionally secured in the axial direction. In this regard, the target holder 4 comes into axial contact with the push rod 2 in both axial directions with the first snap-fit contour 8 or the second snap-fit contour 9.

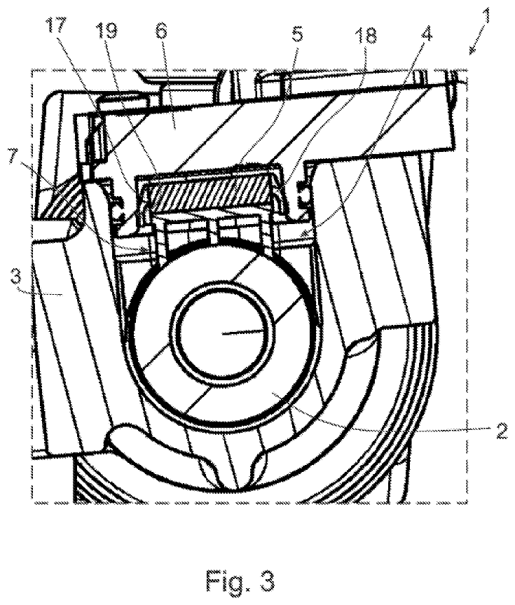

As FIGS. 3 to 5 show, two resiliently deformable spring tabs 17, 18 are also formed on the base part 7. One spring tab 17, 18 each is arranged on a side surface 16 of the base part. The target holder 4 is supported on the sensor arrangement 6 in both circumferential directions around the push rod 2 via the spring tabs 17, 18. For this purpose, the sensor arrangement 6 has a receptacle 19 into which the base part 7 with the target 5 projects in such a way that the spring tabs 17, 18 can be supported on the walls of the receptacle 19. Manufacturing tolerances are compensated for by means of the spring tabs 17, 18. In addition, the target holder 4 is secured against rotation relative to the push rod 2 and the sensor arrangement. This allows measurement inaccuracies during operation of the axle steering system 12 to be reduced, in particular eliminated. The spring tabs 17, 18 have such elastic properties that the target holder 4 is held in a rotational normal position. The spring tabs 17, 18 are latching arms which are supported on the base part 7 of the target holder 4 on the one hand and on the sensor arrangement 6 on the other.

FIG. 6 shows an alternative embodiment of the target holder 4. The target holder 4 shown in FIG. 6 is essentially identical to the target holder 4 shown in FIGS. 3 to 5. In the present case, the main difference to the first exemplary embodiment is that the spring tabs 17, 18 are designed to be comparatively longer. This allows for an intermediate positioning of the target holder 4 on the housing 3 when mounting the actuator. Namely, after mounting the push rod 2 in the housing and before mounting the sensor arrangement 6, the target holder 4 is supported on the housing 3 in the circumferential direction. This optimizes the mounting of the sensor arrangement 6, as the target holder 4 is already centered in the rotational normal position, i.e., pre-positioned.

When mounting the sensor arrangement 6 on the housing 3, the spring tabs 17, 18 are pressed further inwards by the sensor cover. Consequently, the spring tabs 17, 18 continue to deform elastically in such a way that, after the sensor arrangement 6 has been mounted on the housing 3, they only come into contact with the inner wall in the receptacle 19 of the sensor arrangement 6 and no longer with the housing 3. This ensures low-friction operation of the actuator 1, in particular low-friction guidance of the target holder within the housing 3 or along the sensor arrangement 6.

### LIST OF REFERENCE SYMBOLS

1 Actuator
2 Push rod
3 Housing
4 Target holder
5 Target
6 Sensor arrangement
7 Base part
8 First snap-fit contour
9 Second snap-fit contour
First snap-fit arm
11 Second snap-fit arm
12 Axle steering system
13 Fork element
14 Drive unit
15 Tapering
16 Side surface
17 First spring tab
18 Second spring tab
19 Receptacle of the sensor arrangement

1. An actuator for an axle steering system of a vehicle, comprising:
a push rod movable longitudinally within a housing,
a target holder for a target fastened releasably on the push rod, the target configured to cooperate with a stationary sensor arrangement to provide an axial position of the push rod, and
the target holder comprises:
a base part for receiving the target, and
at least one first snap-fit contour integrally formed on the base part, the at least one first snap-fit contour: i) configured to engage at least partially around the push rod and ii) has a first snap-fit arm and a second snap-fit arm.

2. The actuator according to claim 1, wherein the target holder further comprises a second snap-fit contour axially spaced apart from the first snap-fit contour and having a third snap-fit arm and a fourth snap-fit arm.

3. The actuator according to claim 2, wherein the push rod has a radial tapering for radially receiving the respective snap-fit contour.

4. The actuator according to claim 1, wherein the target holder further comprises at least one resiliently deformable spring tab on each of two side surfaces of the base part, the two side surfaces guided by the housing, the at least one resiliently deformable spring tab configured to secure the target holder against rotation relative to the stationary sensor arrangement.

5. The actuator according to claim 4, wherein the at least one resiliently deformable spring tab is configured to pre-position the target holder relative to the housing before the stationary sensor arrangement is mounted on the housing.

6. The actuator according to claim 5, wherein the at least one resiliently deformable spring tab is configured to guide the target holder on the stationary sensor arrangement and do not come into contact with the housing after the stationary sensor arrangement has been mounted on the housing.

7. The actuator according to claim 1, wherein the stationary sensor arrangement has a receptacle into which the base part projects at least partially.

8. An axle steering system for a vehicle, comprising an actuator according to claim 2.

9. A vehicle, comprising at least one axle steering system according to claim 8.

10. The actuator according to claim 1, wherein the first snap-fit arm and the second snap-fit arm form a C-shaped contour.

11. The actuator according to claim 10, wherein a circumference of the C-shaped contour is larger than half the circumference of the push rod.

12. The actuator according to claim 1, wherein the first snap-fit arm and the second snap-fit arm are curved.

13. The actuator according to claim 1, wherein the target holder and the push rod move longitudinally together within the housing.

14. The actuator according to claim 1, wherein the target holder further comprises two resiliently deformable spring tabs configured to secure the target holder against rotation relative to the stationary sensor arrangement.

15. The actuator according to claim 14, wherein the two resiliently deformable spring tabs are elastically pressed towards one another when the target holder is mounted on the housing.

16. An actuator for an axle steering system of a vehicle, comprising:
a push rod movable longitudinally within a housing,
a target holder fastened circumferentially around the push rod via a resilient C-shaped contour,
a target overmolded by a plastic material of the target holder so as to fix the target to the target holder,
a stationary sensor arrangement mounted to the housing and configured to springably receive the target holder, the stationary sensor arrangement configured to cooperate with the target to provide an axial position of the push rod when the target moves together with the push rod and relative to the stationary sensor arrangement.

17. The actuator according to claim 16, wherein the stationary sensor arrangement further comprises a receptacle configured to springably receive the target holder.

18. The actuator according to claim 17, wherein the target holder further comprises two resiliently deformable spring tabs configured to springably engage walls of the receptacle.

19. The actuator according to claim 16, wherein the resilient C-shaped contour forms a snap fit with the push rod.

20. The actuator according to claim 19, wherein the target is arranged radially outwardly of the resilient C-shaped contour.
